(19) United States
(12) Patent Application Publication
(10) Pub. No.: US 2026/0149225 A1
(43) Pub. Date: May 28, 2026

(54) SHIELD TERMINAL

(71) Applicant: SUMITOMO WIRING SYSTEMS, LTD., Mie (JP)

(72) Inventors: Hiroki KATO, Mie (JP); Temma FUJIOKA, Mie (JP)

(21) Appl. No.: 19/400,086

(22) Filed: Nov. 25, 2025

(30) Foreign Application Priority Data
Nov. 26, 2024 (JP) 2024-205437

(51) Int. Cl. H01R 13/6591; H01R 13/02; H01R 13/405; H01R 13/58

(52) U.S. Cl. CPC H01R 13/65912; H01R 13/025; H01R 13/405; H01R 13/582

(57) ABSTRACT

A shield terminal includes two inner conductors, a dielectric that houses the two inner conductors, and an impedance adjustment member that maintains a certain distance between the electric wires respectively connected to the two inner conductors. The impedance adjustment member is positioned and held by the dielectric.

### CROSS-REFERENCE TO RELATED APPLICATIONS

This application is based on and claims priority from Japanese Patent Application No. 2024-205437, filed on Nov. 26, 2024, with the Japan Patent Office, the disclosure of which is incorporated herein in its entirety by reference.

### TECHNICAL FIELD

The present disclosure relates to a shield terminal.

### BACKGROUND

A connector described in JP 2023-018173 A includes an inner conductor connected to an electric wire, a dielectric that houses the inner conductor, and an impedance adjustment member that is crimped to the electric wire. The inner conductor has a base portion and an insulation barrel piece that rises from the base portion and is crimped to a coating of the electric wire. The impedance adjustment member is crimped to two parallel electric wires rearward of the dielectric.

### SUMMARY

If a relative position between the impedance adjustment member and the inner conductor shifts in an extension direction of the electric wire when the impedance adjustment member is crimped to the electric wire, there is a concern that impedance stability may be impaired, affecting transmission performance.

Therefore, an object of the present disclosure is to provide a shield terminal that can improve the transmission performance.

The shield terminal of the present disclosure includes two inner conductors; a dielectric housing the two inner conductors; and an impedance adjustment member configured to maintain a certain distance between electric wires respectively connected to the two inner conductors, in which the impedance adjustment member is positioned and held by the dielectric.

An object of the present disclosure is to provide a shield terminal that can improve transmission performance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a shield terminal according to a first embodiment.

FIG. 2 is a side sectional view of the shield terminal according to the first embodiment.

FIG. 3 is an exploded perspective view of a first dielectric and a first adjustment member in the shield terminal according to the first embodiment.

FIG. 4 is an exploded perspective view of a second dielectric and a second adjustment member in the shield terminal according to the first embodiment.

FIG. 5 is a perspective view illustrating a state in which the first adjustment member is positioned and held by the first dielectric in the shield terminal according to the first embodiment.

FIG. 6 is an enlarged cross-sectional view of a portion of the shield terminal according to the first embodiment cut at a position (rear portion) where the thickness of a locking portion in an up-down direction is small.

FIG. 7 is an enlarged cross-sectional view of a portion of the shield terminal according to the first embodiment cut at a position (front portion) where the thickness of the locking portion in the up-down direction is large.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

(1) A shield terminal of the present disclosure includes: two inner conductors; a dielectric housing the two inner conductors; and an impedance adjustment member configured to maintain a certain distance between electric wires respectively connected to the two inner conductors, in which the impedance adjustment member is positioned and held by the dielectric.

Since the inner conductor is housed in the dielectric and the impedance adjustment member is positioned and held by the dielectric, a position between the inner conductor and the impedance adjustment member can be kept constant in an extension direction of the electric wire. As a result, impedance stability can be ensured and transmission performance can be improved. In addition, a process of crimping the impedance adjustment member to the electric wire can be omitted, thereby simplifying a work process.

(2) In the shield terminal according to (1) above, it is preferable that the dielectric includes a first dielectric and a second dielectric that form a pair in an up-down direction intersecting an extension direction of the electric wires, the impedance adjustment member includes a first adjustment member and a second adjustment member that form a pair in the up-down direction, the first adjustment member is positioned and held by the first dielectric, the second adjustment member is positioned and held by the second dielectric, and a holding space in which the electric wires are held is provided between the first adjustment member and the second adjustment member.

According to the configuration of (2) above, the electric wires can be positioned and fixed in the holding space provided between the first adjustment member and the second adjustment member, and therefore transmission characteristics can be further improved.

(3) In the shield terminal according to (1) or (2) above, it is preferable that the dielectric has a recessed receiving surface along an outer surface of the impedance adjustment member, and a locking portion that suppresses separation of the impedance adjustment member from the receiving surface.

According to the configuration of (3) above, the impedance adjustment member can be stably maintained in a state of being positioned and held by the dielectric, for example, even in a vibration environment.

(4) In the shield terminal according to (3) above, it is preferable that the impedance adjustment member has chamfered surfaces at outer corners at both ends in a left-right direction, and the locking portions have shapes protruding inward in the left-right direction from both ends in the left-right direction of the receiving surface, and have locking surfaces disposed along the chamfered surfaces.

According to the configuration of (4) above, since locking partners of the locking portions are the chamfered surfaces that are generally provided on the impedance adjustment member, there is no need to perform special processing on the impedance adjustment member, and the configuration of the impedance adjustment member can be simplified.

(5) In the shield terminal according to (4) above, it is preferable that the locking portions are fixed in contact with the chamfered surfaces.

According to a configuration of (5) above, since the locking portions are fixed to the chamfered surfaces, the impedance adjustment member is held on the receiving surface without rattling.

### Details of Embodiments of the Present Disclosure

Specific examples of the embodiments of the present disclosure will be described below with reference to the drawings. Note that the present invention is not limited to the examples, but is indicated by the scope of the claims, and is intended to include meanings equivalent to the scope of the claims and all changes within the scope of the claims.

### First Embodiment

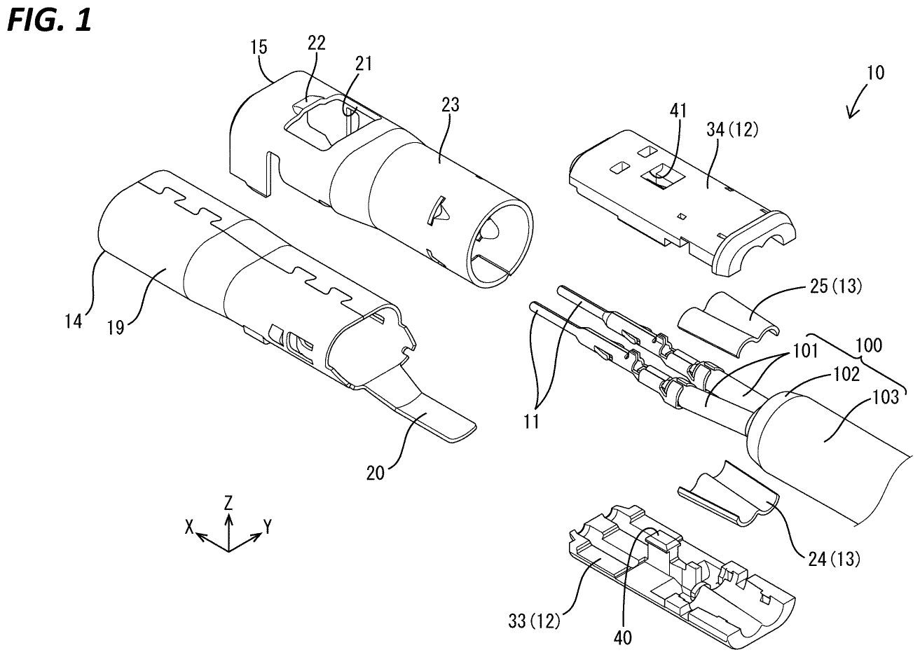

A shield terminal 10 of this first embodiment is connected to an end of a cable 100 through which communication signals are transmitted. In this first embodiment, the cable 100 is a shielded twisted pair (STP) cable. As illustrated in FIG. 1, the shield terminal 10 includes two inner conductors 11, a dielectric 12 that houses the inner conductors 11, an impedance adjustment member 13 held by the dielectric 12, an outer conductor 14 that houses the dielectric 12, and an outer conductor cover 15 attached to the outer conductor 14. Note that in the following description, the up-down direction is synonymous with a height direction, and the left-right direction is synonymous with a width direction. X, Y, and Z in FIG. 1 respectively represent frontward, rightward, and upward. These directional references are for convenience and do not necessarily coincide with directional references when the shield terminal 10 is mounted in a vehicle or the like (not illustrated).

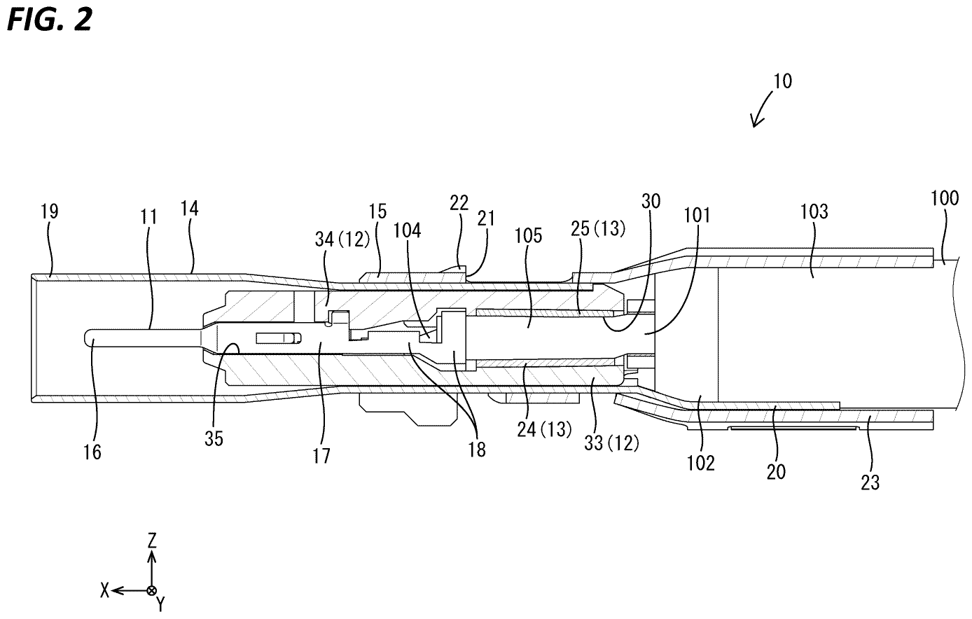

As illustrated in FIGS. 1 and 2, the cable 100 includes two electric wires 101, a shield 102 such as a braided wire that collectively covers an outer periphery of the electric wires 101, and an insulating sheath 103 that covers an outer periphery of the shield 102. The electric wires 101 are insulated wires, and include a conductive core wire 104 and an insulating coating 105 that covers an outer periphery of the core wire 104. In this first embodiment, each electric wire 101 is a twisted pair wire. At a front end of the cable 100, the sheath 103 is removed to expose the electric wires 101.

### (Inner Conductor 11)

An inner conductor 11 is formed, for example, by bending a conductive metal plate. As illustrated in FIGS. 1 and 2, the inner conductor 11 is a male terminal. The inner conductor 11 has a tab 16 extending elongatedly forward, a tubular terminal body 17 connected to a rear portion of the tab 16, and a barrel-shaped wire connecting portion 18 connected to a rear portion of the terminal body 17. As illustrated in FIG. 2, the wire connecting portion 18 is crimped and connected to the core wire 104 and the coating 105 exposed at a front end of the electric wire 101.

### (Outer Conductor 14)

The outer conductor 14 is formed, for example, by bending a conductive metal plate. As illustrated in FIG. 1, the outer conductor 14 has a tubular fitting tube portion 19 with its axis oriented in a front-rear direction. The dielectric 12 is inserted into the fitting tube portion 19 from the rear and housed therein. As illustrated in FIG. 2, when the dielectric 12 is housed in a rear portion inside the fitting tube portion 19, the tab 16 of the inner conductor 11 is disposed to protrude at a front portion inside the fitting tube portion 19.

The outer conductor 14 has a strip-shaped shield connecting portion 20 that extends rearward from a lower edge of a rear end of the fitting tube portion 19. The shield connecting portion 20 is disposed below the shield 102 and is connected to the shield 102 by receiving a crimping force of the outer conductor cover 15.

### (Outer Conductor Cover 15)

The outer conductor cover 15 is formed, for example, by bending the conductive metal plate. As illustrated in FIG. 2, a rear portion of the fitting tube portion 19 is disposed inside a front portion of the outer conductor cover 15. As illustrated in FIG. 1, an opening 21 that opens in the up-down direction and a lance-locked portion 22 protruding upward from a front edge of the opening 21 are formed in an upper wall of the front portion of the outer conductor cover 15. The lance-locked portion 22 locks the shield terminal 10 to a lance of a housing of a partner connector (not illustrated).

A shield barrel portion 23 is formed at a rear portion of the outer conductor cover 15. As illustrated in FIG. 2, the shield barrel portion 23 is crimped and connected to the shield 102 of the cable 100 while the shield connecting portion 20 of the outer conductor 14 is disposed inside the shield barrel portion 23. Note that for convenience of drawing, the outer conductor cover 15 illustrated in FIG. 1 is shown with a deformed form obtained by being crimped to the shield 102 of the cable 100.

### (Impedance Adjustment Member 13)

The impedance adjustment member 13 is formed, for example, by bending a conductive metal plate. The impedance adjustment member 13 includes a first adjustment member 24 and a second adjustment member 25 that form a pair in the up-down direction. In this first embodiment, the first adjustment member 24 and the second adjustment member 25 have the same shape and are arranged opposite each other in the up-down direction. Note that a configuration of the first adjustment member 24 will be described in detail, and a configuration of the second adjustment member 25 will be described as needed below. Also, in the following description, up-down orientations of the first adjustment member 24 and the second adjustment member 25 are opposite to each other.

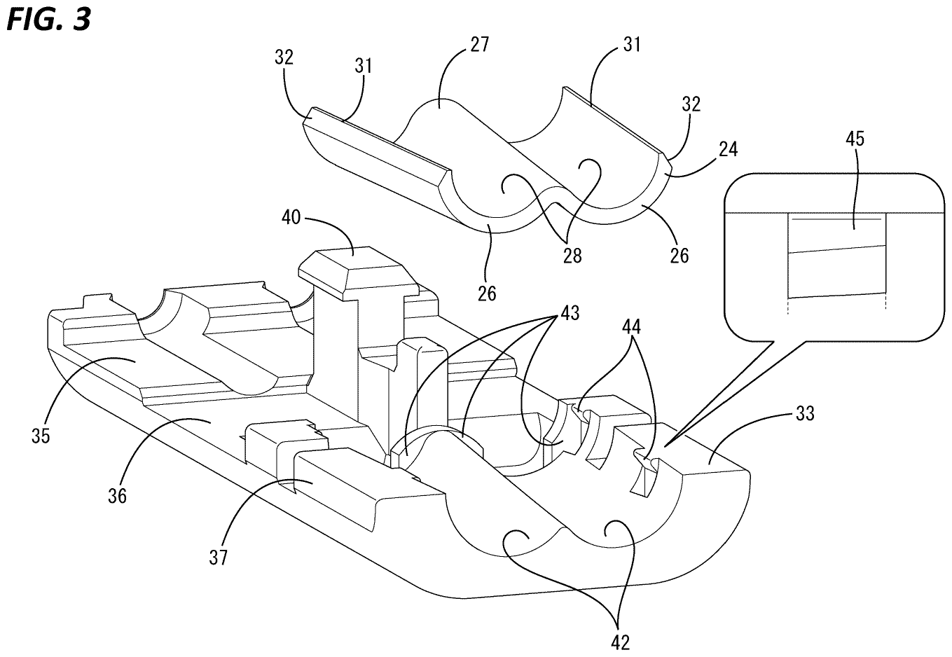

As illustrated in FIG. 3, the first adjustment member 24 has two adjustment main bodies 26 that hold coatings 105 of the electric wires 101 exposed at the front end of the cable 100, and a connection portion 27 that connects the adjustment main bodies 26. A front-rear dimension of the first adjustment member 24 is longer than a left-right dimension of the first adjustment member 24.

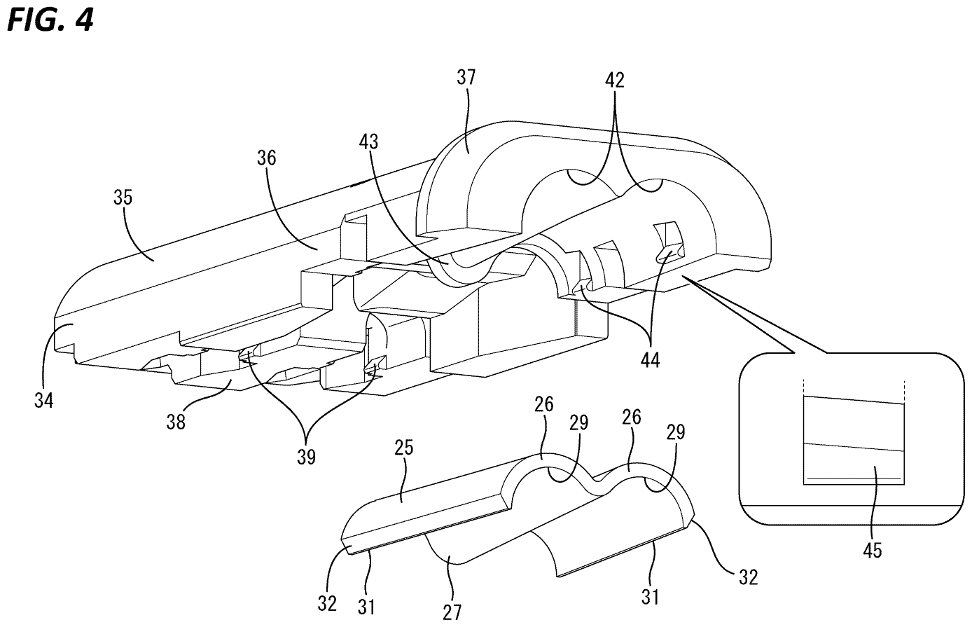

An upper surface of the adjustment main body 26 of the first adjustment member 24 forms a first wire holding surface 28. As illustrated in FIG. 4, a lower surface of the adjustment main body 26 of the second adjustment member 25 forms a second wire holding surface 29. A cross-sectional shape (cross-sectional shape taken in the left-right direction) of each of the first wire holding surface 28 and the second wire holding surface 29 is an arc that follows an outer peripheral surface of the electric wire 101. When the first adjustment member 24 and the second adjustment member 25 are assembled together, a holding space 30 in which the electric wire 101 is sandwiched and held is formed between the first wire holding surface 28 and the second wire holding surface 29 (see FIG. 2).

The connection portion 27 has a curved shape that bulges upward, and connects the adjustment main bodies 26 in the left-right direction. The connection portion 27 is formed so as to have a front portion wider than a rear portion in the left-right direction. Thus, the impedance adjustment member 13 has a front portion wider than a rear portion in the left-right direction.

The connection portion 27 is formed so as to be inclined upward toward the front. Thus, when the first adjustment member 24 and the second adjustment member 25 are assembled together, a distance in the up-down direction between the first adjustment member 24 and the second adjustment member 25 gradually decreases toward the front.

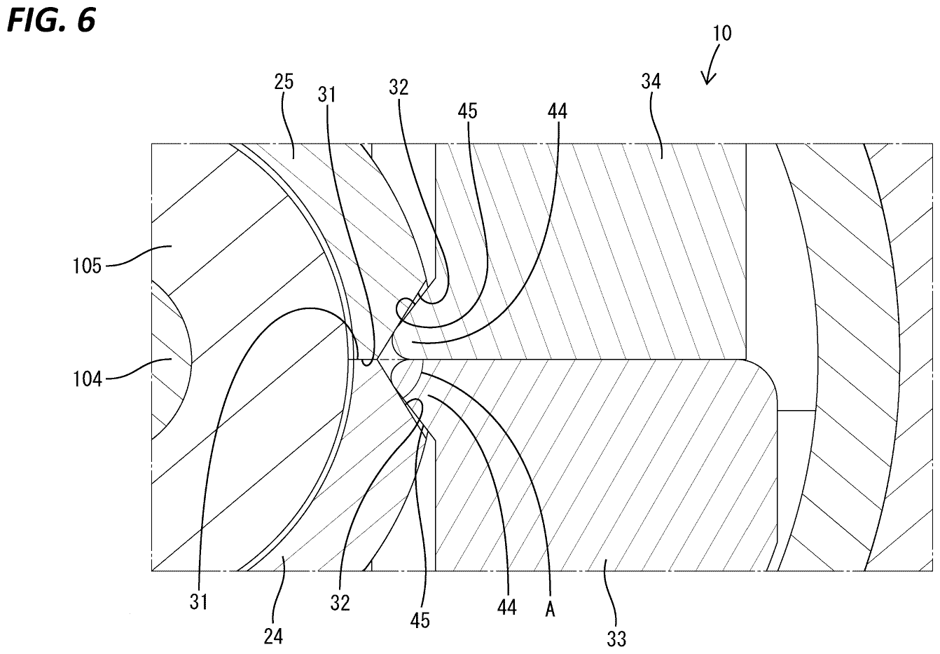

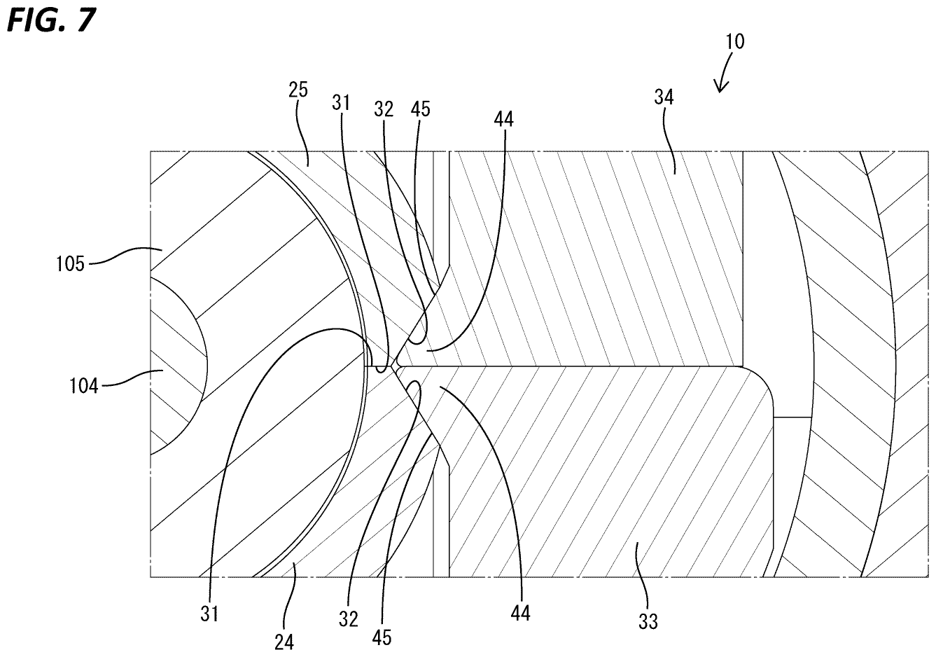

Both left and right end surfaces of the first adjustment member 24, that is, a left end surface of the adjustment main body 26 on the left side and a right end surface of the adjustment main body 26 on the right side are arranged facing upward. Both the left and right end surfaces of the first adjustment member 24 have opposing surfaces 31 on the inner sides in the left-right direction, and chamfered surfaces 32 inclined downward on the outer sides in the left-right direction at outer corners in the left-right direction (see FIGS. 6 and 7). A length (width) of the chamfered surface 32 in an inclination direction is longer than a length (width) of the opposing surface 31 in the left-right direction. The chamfered surface 32 is inclined at an angle greater than 45 degrees with respect to an imaginary line obtained by extending the opposing surface 31 outward in the left and right direction (see angle A in FIG. 6).

### (Dielectric 12)

The dielectric 12 is made of an insulating synthetic resin and is elongated in the front-rear direction relative to the left-right direction. The dielectric 12 can be separated in the up-down direction and includes a first dielectric 33 that is a lower member and a second dielectric 34 that is an upper member. Basic configurations of the first dielectric 33 and the second dielectric 34 are identical. Therefore, a configuration of the first dielectric 33 will be described in detail, and a configuration of the second dielectric 34 will be described as needed below. Note that in the description below, the up-down orientations of the first dielectric 33 and the second dielectric 34 are opposite to each other.

As illustrated in FIG. 3, the first dielectric 33 is configured by sequentially connecting an inner conductor receiving portion 35, an intermediate portion 36, and a holding portion 37 from the front side to the rear side.

The inner conductor receiving portion 35 is a plate-like portion that receives the two inner conductors 11. The two inner conductors 11 are positioned and held between the inner conductor receiving portion 35 of the first dielectric 33 and the inner conductor receiving portion 35 of the second dielectric 34. As illustrated in FIG. 4, in the inner conductor receiving portion 35 of the second dielectric 34, a partition wall 38 that separates the two inner conductors 11 is formed, and holding protrusions 39 (an inner conductor positioning portion) that prevent the two inner conductors 11 from falling out are formed at positions facing an upper end of the partition wall 38. The tab 16 of the inner conductor 11 protrudes frontward from a front end of the inner conductor receiving portion 35.

The intermediate portion 36 has a plate-like portion that continues from the inner conductor receiving portion 35, and further has a locking portion 40 that protrudes upward from an intermediate portion of the plate-like portion in the left-right direction. The locking portion 40 is locked to a locked portion 41 of the second dielectric 34. The locked portion 41 is formed as a through-hole that penetrates in the up-down direction at a position corresponding to the locking portion 40 (see FIG. 1). When the first dielectric 33 and the second dielectric 34 are assembled together, the locking portion 40 is inserted into and locked to the locked portion 41.

As illustrated in FIG. 3, the holding portion 37 is plate-shaped and has an upper surface recessed along an outer surface of the impedance adjustment member 13. The upper surface of the holding portion 37 constitutes a receiving surface 42 that receives the impedance adjustment member 13. Specifically, receiving surfaces 42 are curved surfaces that curve along outer peripheries of the adjustment main bodies 26, and are provided in a pair in the left-right direction to correspond to the adjustment main bodies 26. A portion between the receiving surfaces 42 is a portion facing the connection portion 27 and extends in the front-rear direction between upper ends of the receiving surfaces 42. The portion between the receiving surfaces 42 is inclined to be higher toward the front. The receiving surface 42 is formed to be wider in the left-right direction toward the front. The impedance adjustment member 13 is prevented from slipping rearward from the holding portion 37 by the receiving surface 42 being wider toward the front. Further, the impedance adjustment member 13 is prevented from slipping upward from the holding portion 37 by locking portions 44 described below.

A front end surface of the holding portion 37 is configured as a front stop surface 43. The front stop surface 43 is an end surface facing rearward and is disposed in the up-down direction and in the left-right direction. The front stop surface 43 is also a rear end surface of the intermediate portion 36. In this first embodiment, the front stop surface 43 is perpendicular to front ends of the receiving surfaces 42. The impedance adjustment member 13 comes into contact with the front stop surface 43, thereby preventing forward movement (misalignment).

The holding portion 37 has pairs of locking portions 44 on the left and right sides that protrude inward from both ends in the left-right direction of the receiving surfaces 42 (the upper ends of the receiving surfaces 42, that is, a left end of the receiving surface 42 on the left side and a right end of the receiving surface 42 on the right side). In this first embodiment, the locking portions 44 are arranged side by side spaced apart in the front-rear direction, one on the front side and one on the rear side of the receiving surface 42. The locking portion 44 on the front side is connected to the front stop surface 43. The locking portion 44 on the front side is disposed frontward and away from a rear end of the holding portion 37. The locking portions 44 forming pairs on the left and right sides have symmetrical shapes in the left-right direction.

As illustrated in FIG. 3, each locking portion 44 has a rib shape extending in the front-rear direction. The tip of each locking portion 44 is rounded (see FIG. 6). The thickness in the up-down direction (vertical dimension) of each locking portion 44 increases toward the front. An amount of inward protrusion of each locking portion 44 increases toward the front.

A lower surface of each locking portion 44 is configured as a locking surface 45 that comes into contact with the chamfered surface 32. Specifically, the lower surface of each locking portion 44 intersects and comes into contact with the chamfered surface 32 at a rear portion where the thickness in the up-down direction is small (see FIG. 6), and makes surface contact along the chamfered surface 32 at a front portion where the thickness in the up-down direction is large (see FIG. 7). The locking surface 45 is inclined downward toward the front. The locking surface 45 is formed such that its area increases toward the front. When the impedance adjustment member 13 is assembled to the dielectric 12, the locking surface 45 faces the chamfered surface 32 of the impedance adjustment member 13 in a contactable manner.

### (Assembly Procedure of Shield Terminal 10)

Subsequently, an example of an assembly procedure of the shield terminal 10 will be described.

The sheath 103 is stripped from the end of the cable 100 to expose the electric wires 101, which are a twisted pair wire. Ends of the electric wires 101 are untwisted, and the coatings 105 are stripped to expose the core wires 104. The wire connecting portion 18 of the inner conductor 11 is crimped to the exposed core wire 104.

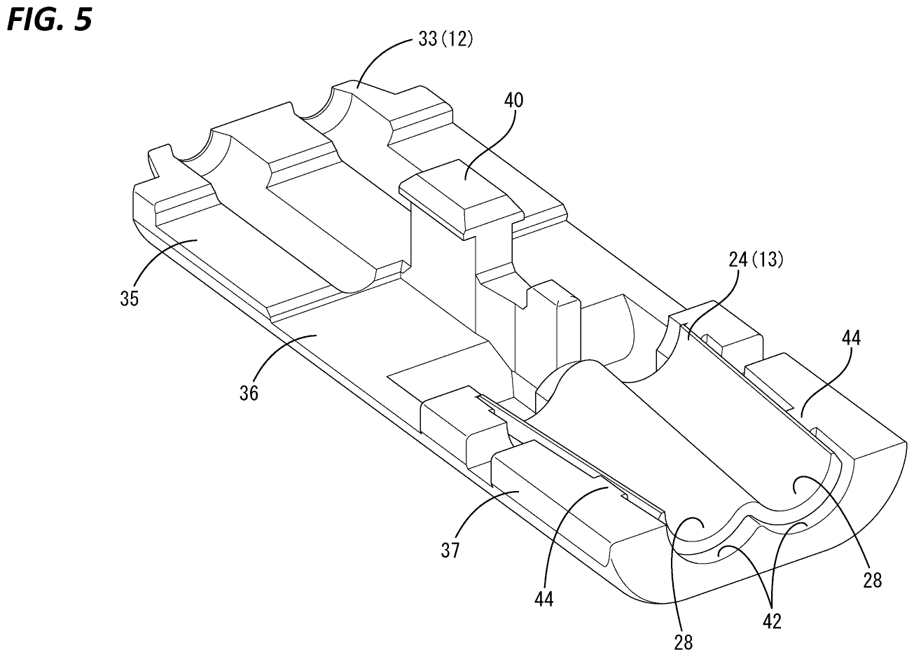

Separately, the impedance adjustment member 13 is attached to the dielectric 12. That is, the first adjustment member 24 and the second adjustment member 25 are respectively attached to the first dielectric 33 and the second dielectric 34. Specifically, the outer surface of the impedance adjustment member 13 (surface opposite to the first wire holding surface 28 and the second wire holding surface 29) is brought closer to the receiving surface 42 of the dielectric 12. Then, side surfaces facing outward in the left-right direction on the outer surface of the impedance adjustment member 13 come into contact with each locking portion 44, and each locking portion 44 is elastically deformed. A front portion of each locking portion 44 is crushed. When the outer surface of the impedance adjustment member 13 reaches a position where it is in contact with the receiving surface 42, the locking surface 45 of each locking portion 44 faces the chamfered surface 32. As illustrated in FIG. 6, a rear portion of each locking portion 44 is in contact with or faces the chamfered surface 32 with a gap therebetween. On the other hand, the amount of inward protrusion of each locking portion 44 increases toward the front. Therefore, the front portion of each locking portion 44 is firmly in contact with and fixed to the chamfered surface 32 (see FIG. 7). As a result, the impedance adjustment member 13 is assembled to the dielectric 12 while separation of the impedance adjustment member 13 in a direction away from the receiving surface 42 is suppressed by the locking portions 44 (see FIG. 5).

Subsequently, each electric wire 101 is disposed on the second wire holding surface 29 of the second adjustment member 25, and each inner conductor 11 is disposed in the inner conductor receiving portion 35. In this state, the first dielectric 33 and second dielectric 34 are combined and assembled together. Here, the opposing surfaces 31 of the first adjustment member 24 and the second adjustment member 25 face each other in a contactable manner.

Next, the dielectric 12 is inserted from the rear into the fitting tube portion 19 of the outer conductor 14. The dielectric 12 is housed in the fitting tube portion 19, and then the outer conductor cover 15 is lowered from above toward the outer conductor 14. The shield barrel portion 23 of the outer conductor cover 15 is crimped to the shield 102 of the cable 100 while the shield connecting portion 20 of the outer conductor 14 is disposed inside the shield barrel portion 23. This completes assembly of the shield terminal 10.

### (Operation of Shield Terminal 10)

Next, an operation of the shield terminal 10 will be described.

In this first embodiment, the inner conductor 11 is housed in the dielectric 12, and the impedance adjustment member 13 is positioned and held by the dielectric 12. Compared to when the impedance adjustment member is crimped and positioned to the electric wire, a position between the inner conductor 11 and the impedance adjustment member 13 can be kept constant in the extension direction (front-rear direction) of the electric wire 101. As a result, the impedance stability can be ensured and the transmission performance can be improved. Further, the process of crimping the impedance adjustment member 13 to the electric wire 101 can be omitted, thereby simplifying the work process.

The dielectric 12 includes the first dielectric 33 and the second dielectric 34 that form a pair in the up-down direction, and the impedance adjustment member 13 includes the first adjustment member 24 and the second adjustment member 25 that form a pair in the up-down direction. The first adjustment member 24 is positioned and held by the first dielectric 33, and the second adjustment member 25 is positioned and held by the second dielectric 34. The holding space 30 in which the electric wire 101 is held is provided between the first adjustment member 24 and the second adjustment member 25. Therefore, the electric wire 101 can be positioned and fixed in the holding space 30 provided between the first adjustment member 24 and the second adjustment member 25, and therefore the transmission characteristics can be further improved.

The dielectric 12 has the recessed receiving surface 42 that curves along the outer surface of the impedance adjustment member 13, and the locking portions 44 that suppress separation of the impedance adjustment member 13 from the receiving surface 42. Therefore, the impedance adjustment member 13 can be stably maintained in a state of being positioned and held by the dielectric 12 even in a vibration environment or the like.

The impedance adjustment member 13 has the chamfered surfaces 32 at the outer corners at both ends in the left-right direction. The locking portions 44 have shapes protruding inward in the left-right direction from both ends in the left-right direction of the receiving surface 42, and have the locking surfaces 45 disposed along the chamfered surfaces 32. Therefore, since the locking partners of the locking portions 44 are the chamfered surfaces 32 that are generally provided on the impedance adjustment member 13, there is no need to perform special processing on the impedance adjustment member 13, and the configuration of the impedance adjustment member 13 can be simplified.

The locking portions 44 are fixed in contact with the chamfered surfaces 32 (see FIG. 7). Thus, the impedance adjustment member 13 is held on the receiving surface 42 without rattling.

### Other Embodiments of the Present Disclosure

The embodiments disclosed herein should be considered to be illustrative in all respects and not restrictive.

In the first embodiment, the two inner conductors 11 are housed in the dielectric 12. In contrast, in other embodiments, three or more inner conductors may be housed in the dielectric.

In the first embodiment, the first adjustment member 24 and the second adjustment member 25 have the same shape. In contrast, in other embodiments, the first adjustment member and the second adjustment member do not need to have the same shape.

In the first embodiment, the chamfered surface 32 has a shape formed by C-chamfering that is inclined from the outer surface to the inner surface of the adjustment main body 26. In contrast, in other embodiments, the chamfered surface does not need to be formed by C-chamfering. For example, the chamfered surface may have a curved shape formed by R-chamfering.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shield terminal comprising:
two inner conductors;
a dielectric housing the two inner conductors; and
an impedance adjustment member configured to maintain a certain distance between electric wires respectively connected to the two inner conductors,
wherein the impedance adjustment member is positioned and held by the dielectric.

2. The shield terminal according to claim 1, wherein
the dielectric includes a first dielectric and a second dielectric that form a pair in an up-down direction intersecting an extension direction of the electric wires,
the impedance adjustment member includes a first adjustment member and a second adjustment member that form a pair in the up-down direction,
the first adjustment member is positioned and held by the first dielectric,
the second adjustment member is positioned and held by the second dielectric, and
a holding space in which the electric wires are held is provided between the first adjustment member and the second adjustment member.

3. The shield terminal according to claim 1, wherein the dielectric has a recessed receiving surface along an outer surface of the impedance adjustment member, and a locking portion that suppresses separation of the impedance adjustment member from the receiving surface.

4. The shield terminal according to claim 3, wherein
the impedance adjustment member has chamfered surfaces at outer corners at both ends in a left-right direction, and
the locking portions have shapes protruding inward in the left-right direction from both ends in the left-right direction of the receiving surface, and have locking surfaces disposed along the chamfered surfaces.

5. The shield terminal according to claim 4, wherein the locking portions are fixed in contact with the chamfered surfaces.
